(19) United States
(12) Patent Application Publication
(10) Pub. No.: US 2009/0319622 A1
(43) Pub. Date: Dec. 24, 2009

(54) METHOD AND SYSTEM FOR DOCUMENTING GROUP HISTORY AND EVENTS

(76) Inventors: Terry G. Vavra, Allendale, NJ (US); Stacy D. Roux, Fairfax, VA (US); Kerry L. Vavra, Glen Allen, VA (US); Tammy G. Collins, Glen Allen, VA (US)

Correspondence Address: DITTHAVONG MORI & STEINER, P.C., 918 Prince St., Alexandria, VA, 22314, US

(21) Appl. No.: 12/145,267

(22) Filed: Jun. 24, 2008

(51) Int. Cl. G06F 15/16; G06Q 99/00

(52) U.S. Cl. 709/206; 705/1

(57) ABSTRACT

An approach is provided for documenting family history in a central location and enabling family members to create messages for delivery to other members in the future based on the occurrence of specific events (e.g., family activities, special occasions, holidays, etc.).

### BACKGROUND OF THE INVENTION

Studies have shown that effective communication among family members is critical to developing stronger and healthier family relationships. Ideally, family members should be in an environment where they can easily express their love and admiration for one another, particularly at special family events and occasions. However, modern life has made it much more difficult for families to maintain meaningful lines of communication. A hectic and harried lifestyle combined with increased mobility mean that families have less time for communicating and are much more dispersed than they have been in the past. It is not uncommon for grandparents to live in one state, parents in another, and children in yet another, making it particularly challenging for family members to remain connected.

The dispersion of the family unit further complicates the sharing of family history from one generation to the next. Family history can include a family tree as well as a record of special family events and occasions. Typically, a family's collective history and memories are not found in one central location. Instead, they may be stored away in isolated drawers and attics. It is rare that any one family member would have a complete picture of a family's entire history. As a result, as one generation of a family fades away, so do their memories and presence in the lives of future generations of the family.

Therefore, there is a need for an approach for documenting family history in a central location.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a system for documenting family history and enabling future intra-family communications, according to an exemplary embodiment;

FIG. 2 is a diagram of an exemplary interactive family history and communication system of FIG. 1, in accordance with an embodiment of the present invention;

FIG. 3 is a diagram of a data structure utilized by the database of FIG. 1, according to an exemplary embodiment;

FIG. 4 is a flowchart of a process for documenting family history and enabling future intra-family communications, according to an embodiment of the present invention;

FIG. 5 is a diagram of an exemplary website structure for documenting family history and enabling future intra-family communications, according to an embodiment of the present invention;

FIGS. 6A-8D depict exemplary graphical user interfaces (GUIs) for documenting family history and enabling future intra-family communications, according to various embodiments of the present invention; and

FIG. 7 depicts a computer system that can be used to implement an embodiment of the present invention.

### DESCRIPTION OF THE PREFERRED EMBODIMENT

A system, method, and software for documenting family history and events and delivering future communications based on these events are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention. Further, the many aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

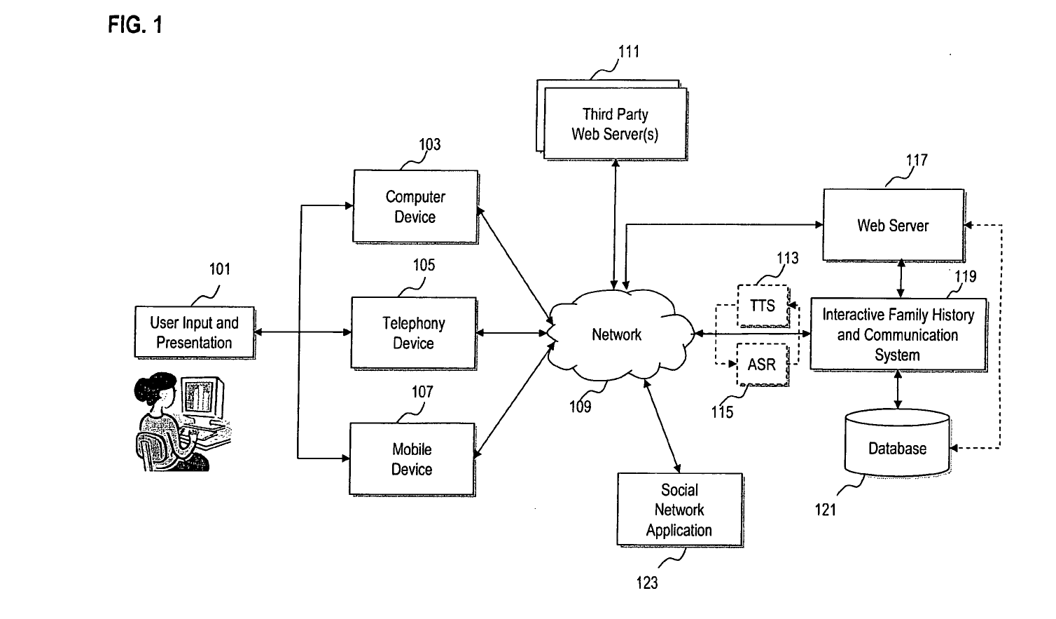

FIG. 1 is a diagram of a system for documenting family history and events and delivering future communications based on these events, according to an exemplary embodiment. For the purposes of illustration, an interactive family history and communication system 119 is described with respect to a communication network 109. It is contemplated that interactive family history and communication system 119 may embody many forms and include multiple and/or alternative components and facilities. System 119 may present family communications in a variety of formats and media such as but not limited to electronic mail, instant messaging, text messaging, voice messaging, and various multimedia files including WAV files, JPEG (Joint Photographic Experts Group) files and MPEG (Moving Pictures Experts Group) files. It also is contemplated that network 109 can be a packet-based network and/or a telephony network and can include: a public data network (e.g., the Internet), various intranets, local area networks (LAN), wide area networks (WAN), the public switched telephony network (PSTN), integrated services digital networks (ISDN), other private packet switched networks or telephony networks, as well as any additional equivalent system or combination thereof.

An interactive family history and communication system 119 of FIG. 1 enables users to enter and view information on family history, relationships and events (e.g., family activities or functions, special occasions, holidays, etc.) through user input and presentation module 101. For example, special family occasions may include weddings, graduations, birthdays, etc. Further, system 119 enables users to create intra-family communications for future delivery based on the occurrence of an event or elapsed time (i.e., user defined schedule). Up to this point, most family history or genealogy systems do not have the capability to provide information on family events and enable family members to create future communications based on these events. This is a shortcoming because family members often times are not aware of all the events affecting other family members, particularly more distant relatives. Consequently, they miss the opportunity to share in and express their thoughts about the event. These events can range from major life events (e.g., graduation, marriage, or birth of a child) to everyday events (e.g., losing a first tooth or getting a driver's license). System 119 enables a user to create a communication well in advance that will be delivered to the appropriate family member when a specific event has occurred or when a predetermined amount of time has passed. This communication system is particularly applicable to cross generation communication because system 119 imposes no temporal limitation on the scheduled communication. The communicating family member's message potentially could be delivered in the next instant or the next few decades depending on the delivery criteria, allowing previous generations to have a “presence” in the lives of subsequent generations of the family through these messages.

To interact with system 119, a user may optionally utilize any one of a computer device 105, telephony device 104, or mobile device 103 available. Computer devices 105 can include one of a desktop computer, notebook computer, server, terminal, workstation, customized hardware, or the like. Telephony devices 104 may include one of a plain-old-telephone, wireless telephone, cellular telephone, satellite telephone, voice over internet protocol telephone, fax machine, etc. Mobile devices 103 may include a personal digital assistant (PDA), a pocket personal computer, a smart phone, a tablet, a handset, customized hardware, or other mobile device capable of transmitting data and/or voice protocols.

Within the broad realm of devices available, many methods of data entry exist. These methods include, but should not be limited to website entry (e.g., data fields, pull-down menus, radio button selections, scalars, checkboxes, etc.), instant messaging, electronic mail, text messaging, specifically designed software application entry, facsimile, voice transmission, postal mailing, and/or the like. As such, a user has the ability to input data in a plain-text, standard language (or near equivalent) format. When input in this format, transmissions will be parsed into the appropriate data parameters by the system 119. Further, data may be entered in one device using one of the above methods and then synchronized to another for transmission.

Further, when a user transmits data in a voice format, the family history and communication system 119 may optionally include a text-to-speech (TTS) engine 113 and/or an automatic speech recognizer (ASR) engine 115 for converting analog to digital signals and vice versa. As such, when a user interacts with the system 119 using voice transmission the ASR 108 converts a user's spoken language (analog signal) into textual form (digital signal) for processing by the system 119. Meanwhile, the TTS engine 113 converts textual information (digital signal) from the system 119 to speech (analog signal) for playback to the user. In this manner, a user may interact with the system 119 receiving and sending information using voice protocols, e.g., voice extensible markup language (VXML) programs. Those skilled in the art will recognize that optionally provided TTS 113 and ASR 115 engines may be collocated or integrated within the system 119 or the network 109. Further, TTS 113 and ASR 115 functionality can be implemented on one of the various input devices, e.g., 103, 105, 107 that are available to the user.

Also, a web server 117, or equivalent online system, can be utilized to permit the user to interface with the family history and communication system 119. The web server 117 may be optionally linked to the database 121 for more efficient extraction of stored family history, events and communications. Moreover, the web server 117 optionally can communicate with one or more third party web servers 111, or equivalent online systems, via network 109 to provide users with third-party services or products that are appropriate to the occurrence of specific family events or occasions.

Thus, from the above description, those skilled in the art should appreciate that the user is not confined to any single method or device for data input. Namely, the user can utilize any combination of methods and/or devices available. Furthermore, the above methods and devices can be implemented in various physical environments, e.g., at user's home or work, at public gym, at recreational center, at strategically placed kiosks, etc. In this regard, users may be allowed to input data temporally close to the time it was collected.

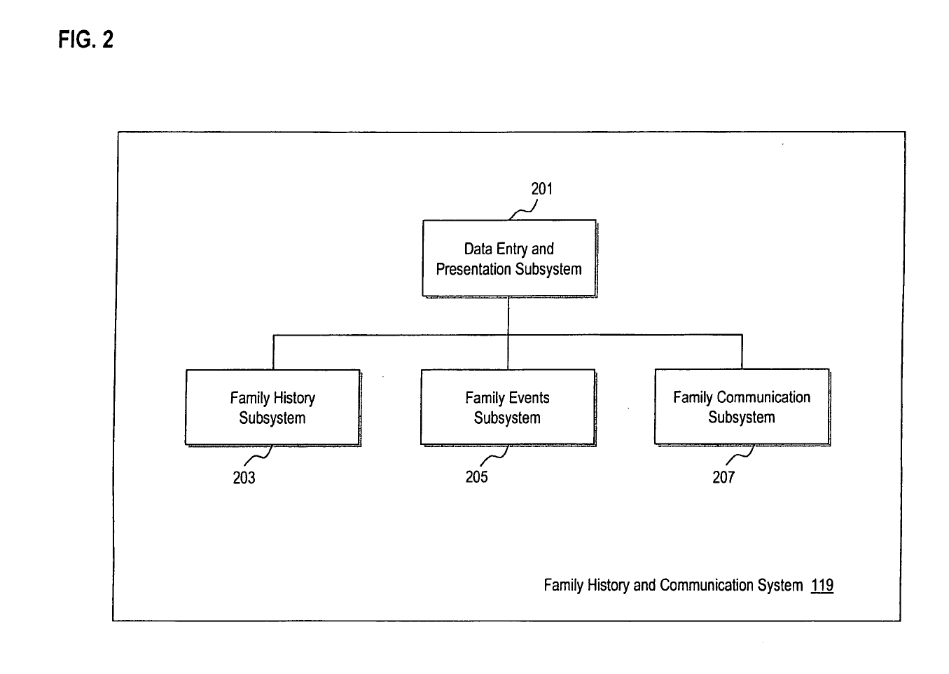

The family history and communication system 119 is configured to allow users to enter and view family history, relationships, events, and communications. This system 119 is further coupled to a database 121 for storing user and family data. Although only a single database 121 is shown, the functionality may be distributed among various databases in a database management system. Further, the database 121 can be collocated with or integrated within the family history and communication system 119. The functional capabilities of the family history and communication system 119 are more fully described with regard to FIG. 2.

Furthermore, the family history and communication system 119 can interface with a third party social network application 123 (e.g., MySpace™, Facebook™, etc.) to link established member profiles with the system 119. In this manner, family members need not provide information about themselves if such relevant information exists within the social network application 123. The system 119 can be configured to generate relevant information from the data resident within the social network application 123.

FIG. 2 is a diagram of an exemplary interactive family history and communication system of FIG. 1, in accordance with an embodiment of the present invention. The system 119 contains various subsystems 201, 203, 205, and 207 for carrying out various embodiments of the present invention. The data entry and presentation subsystem (DEP) 201 allows users to enter and view information on family history, relationships, events and communications. DEP 201 parses user transmitted data into appropriate parameter fields and distributes the parsed data between the other subsystems—i.e., Family History Subsystem 203, Family Events Subsystem 205, and Family Communication Subsystem 207—for aggregation, utilization, manipulation, and analysis. Further, DEP 201 accepts data from these other subsystems for generating reports for users to view family history, relationships, events, and communications. Such reports can be transmitted in visual and/or audio formats. Visual reports might include charts, graphs, lists, tables, text, etc. Audio reports can be explained versions of the visual reports, including recorded audio, human translation, computer generations, and the like.

DEP 201 also communicates with database 121 for data storage and recall.

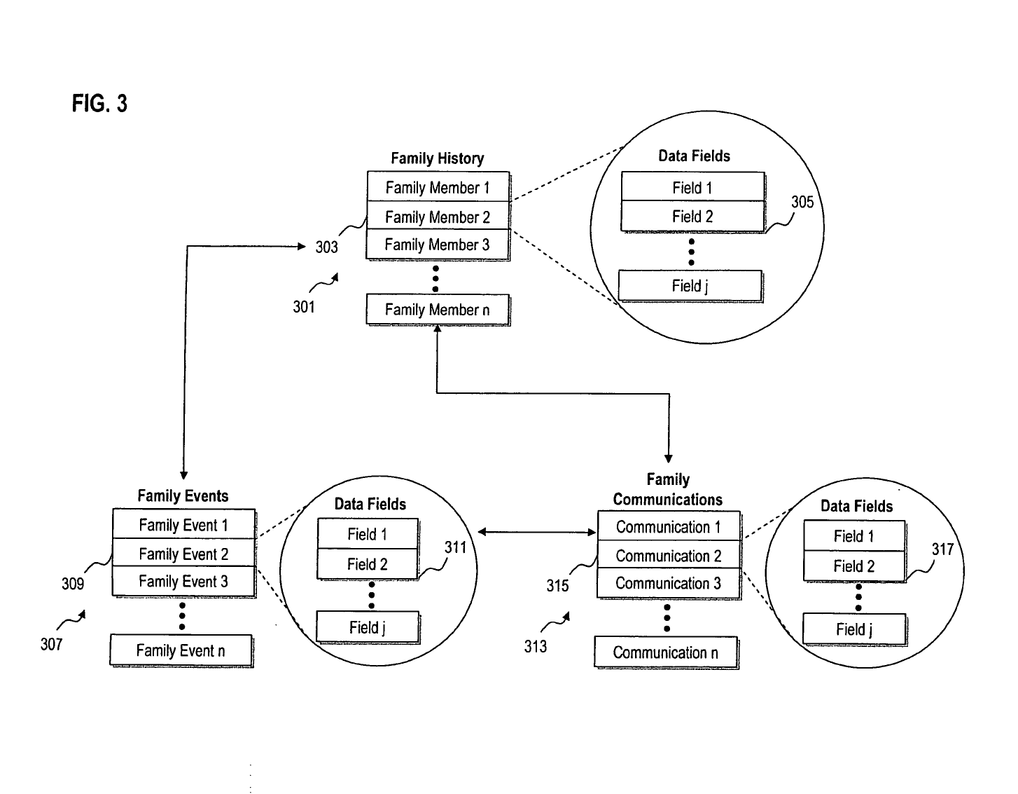

FIG. 3 depicts an exemplary embodiment of a data structure that can be used by the database 121 of FIG. 1, in accordance with an embodiment of the present invention. As in typical database management systems, data can be stored in one or more data containers, each container contains records, and the data within each record is organized into one or more fields. As shown in FIG. 3, there are three related and linked data containers, i.e., a family history data container 301, a family events data container 307, and a family communications data container 313. The family history data container 301 is used to store personal and relationship information about each family member and is correlated from 1 to n (n being an integer) to each family member 303. Further, each family member 303 may be categorized into data fields 305, e.g., 1 to j correlating to the various personal information that the user can enter such as date of birth, relationship, favorite activities, etc. In this regard, the number of data fields, j, may also be dependent upon the level of detail that the user would like to maintain. A family member record 303 may be correlated with a family event record 309 and/or a family communication record 315.

The family events data container 307 is used to store information about family events and special occasions and is similarly correlated from 1 to n (n being an integer) to each recorded family event 309. Further, each family event 309 may be broken down into data fields 311. For example, 1 to j can correlate to details of the family event such as date, location, family members involved, etc. A family event record 309 may be correlated with a family member record 303 and/or a family communication record 315.

Additionally, the family communication data container 313 is used to store information about intra-family communications created for future delivery. This container 313 can be correlated from 1 to n (n being an integer) to each recorded family communication 315. Further, each family communication 315 may be partitioned into data fields 317, whereby 1 to j correlates to details of the family communication including, e.g., date of delivery, delivery triggering event, recipient(s), message content, message format, attachments, etc. A family communication record 317 may be correlated with a family member record 303 and/or a family communication event record 309.

Additionally, while the number of data fields, j, for data containers 301, 307, and 309 can be predefined by system operators, users may also dynamically create optional data fields for more detail or remove data fields for less detail. In this case, users may submit changes, additions, amendments, and deletions to the database structure 121 through family history and communication system 119 using known methods. Such an editing process ensures that family history and communication system 111 is tracking the most appropriate, pertinent data as delineated by the actual user.

The database 121 may allow a user to search for family members 301, family events 309, and family communication 315. This is helpful for users who are not familiar with all family members or events. Further, individuals can use sort-reduction or filtered menu options to narrow the list of possible choices at each successive inquiry. Such a method of data entry and storage represents an improvement over existing data entry and tracking methods because the user no longer has to know the specific name of the record nor the requisite data fields to be entered.

Further, those skilled in the art should appreciate that the database 112 can be configured using other known methods. For instance, in relational database systems, the data containers would be referred to as tables, the records referred to as rows, and the fields referred to as columns. In object-oriented databases, the data containers 301, 307 and 313 would be referred to as object classes, the records referred to as objects, and the fields referred to as attributes. Other database architectures may use other terminology. As such, systems that implement the present invention are not limited to any particular type of data container or database 121 architecture.

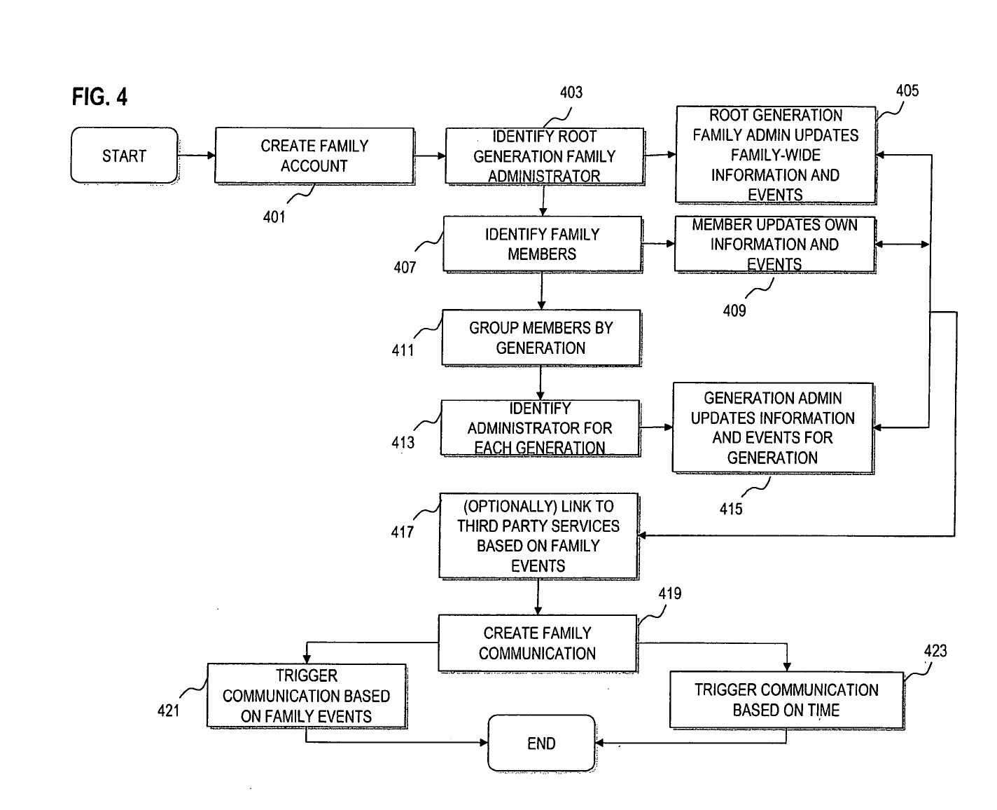

FIG. 4 illustrates a flowchart of a process for documenting family history and enabling future intra-family communications, according to an embodiment of the present invention. The process begins when a user logs into the family history and communication system 119 and creates a password-protected family account, per step 401. The user then identifies a root generation family administrator, per step 403, who is responsible for updating system 119 to include all events and information affecting the entire family per step 405. In this embodiment, the root generation is the family's current generation, which is typically the generation of the family member creating the account. The root generation family administrator may update information directly into the system 119. In addition or alternatively, the system 119 periodically may send the family administrator a form to update family information and events.

Per step 407, the root generation family administrator identifies all known family members and inputs available genealogical information into the system 119. Each family member will then be able to log into the system to update his or her own personal information and events list per step 409. The family member may update information directly into the system 119, or the system 119 periodically may send the member an information update form.

In step 411, the system 119 will group family members by generation. The root generation family administrator then identifies an administrator for each family generation per step 413. Each generation's administrator is responsible for updating system 119 to include all events and information affecting his or her specific generation per step 415. The generation administrator may update information directly into the system 119, or the system 119 periodically may send the generation administrator an information update form.

Each administrator and family member may choose the option to allow information to be shared with third-party providers of services and products. If the user chooses this option, the system 119 will present services and products to the user that are appropriate to specific family events per step 417. For example, if the family administrator records the birth of a baby, the system 119 may present links to third-party florists or a baby clothing store.

Per step 419, any family member may create an intra-family communication message to another family member for delivery in the future based on the occurrence of a family event, special occasion, or elapsed time. The family member may be a known family member (i.e., a family member listed in the system 119) or an anticipated family member (e.g., future grandchild who has yet to be born). For example, a male family member may elect to compose a message to a future grandchild to be delivered upon the grandchild's graduation from high school. It is contemplated that messages can be multimedia (e.g., WAV files, JPEG files, and MPEG files) and take a variety of forms, both electronic and non-electronic (e.g., electronic-mail, flowers, and gifts).

Once the user creates the message and defines the delivery criteria, the system will monitor the family events associated with the intended recipient or recipients to determine when the delivery triggering event has or will occur. When the event occurs, the system 119 will deliver or initiate delivery of the communication per step 421. For example, the message can include one or more of electronic mail, instant messaging, text messaging, voice messaging, multi-media messaging, or multi-media files. In the above example, the system 119 will deliver the message to the grandchild when the child graduate's from high school. If the creator of the message requested delivery of the communication after some elapsed period of time, the system 119 will deliver the message after that period of time has passed per step 423. The purpose of these future communications is to enable family members to avoid forgetting to communicate on important occasions as well as to have the ability to directly communicate their values and beliefs to future descendants.

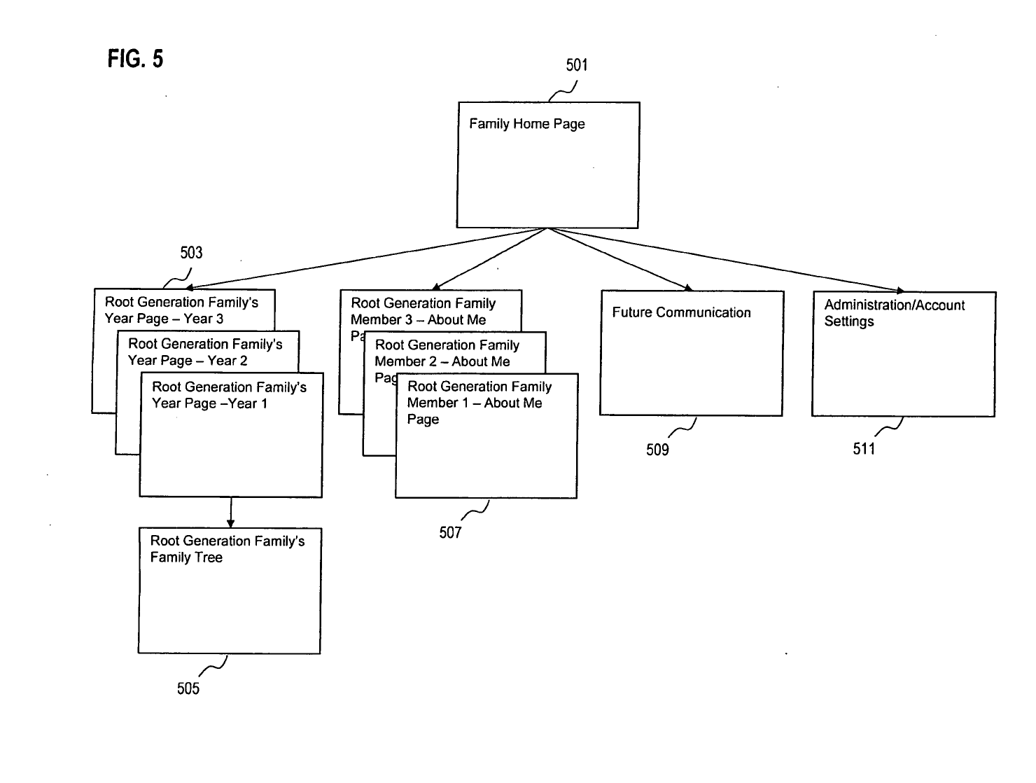

FIG. 5 is a diagram of an exemplary website structure for documenting family history and enabling future intra-family communications, according to an embodiment of the present invention. An exemplary website begins at the family home page 501 which enables users to log onto the system. The family home page 501 also provides information and events relevant to the entire family. As discussed above, the root generation family administrator is responsible for maintaining the information on the family home.

From home page 501, a user may proceed to pages relevant to a specific generation of the family 503 organized by year. These pages provide information and events relevant to one generation of the family and are maintained by the family generation administrator. From this page, a user also can view the generation's family tree 505. The generation administrator can control access to the web pages under his or her control.

Each family also is provided a personal page 507 linked from the home page 501. Personal pages provide information and events specific each family member. Each family member may control access to his or her own page.

The home page 501 also contains a link to the future communication webpage 509 which provides access to creating intra-family communication for future delivery based on the occurrence of specific family events or occasions.

Finally, the home page 501 includes a link to the account settings and administration pages. From this page, the family administrator can administer family members and passwords, email settings, preferences, etc.

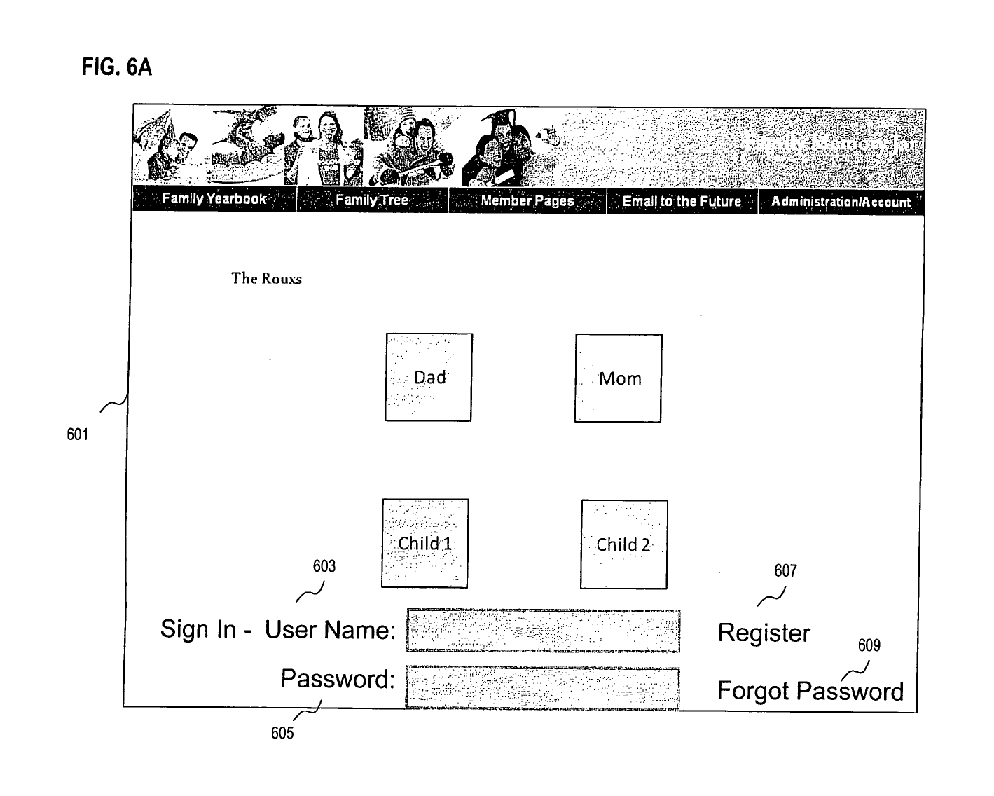

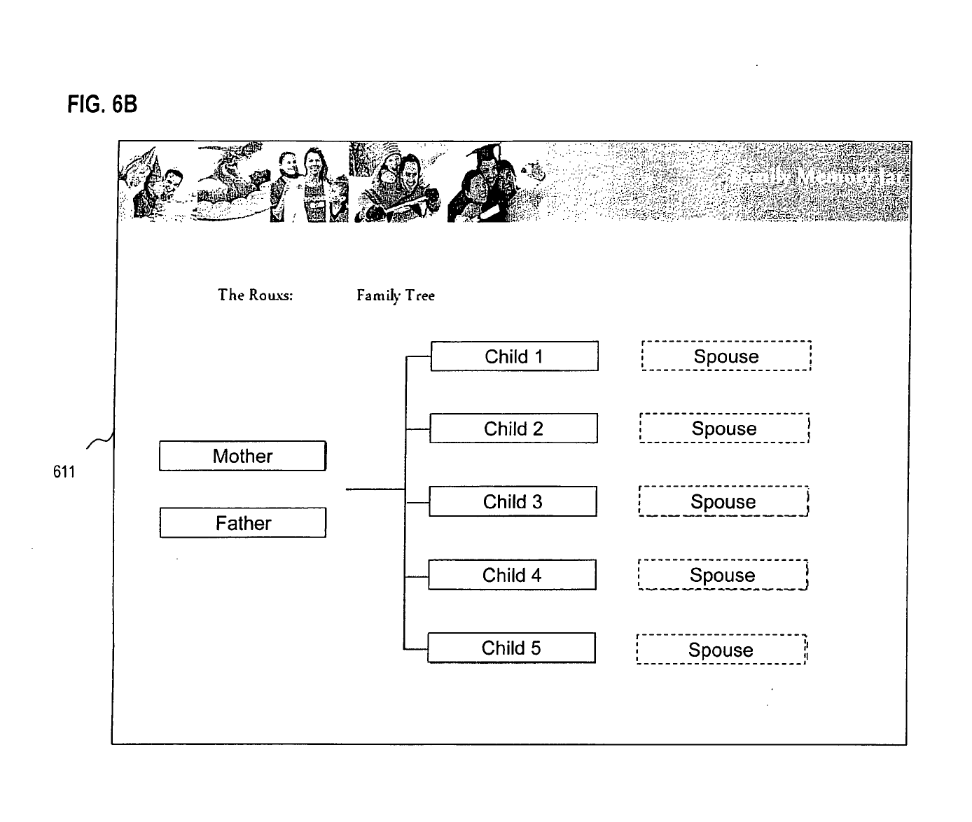

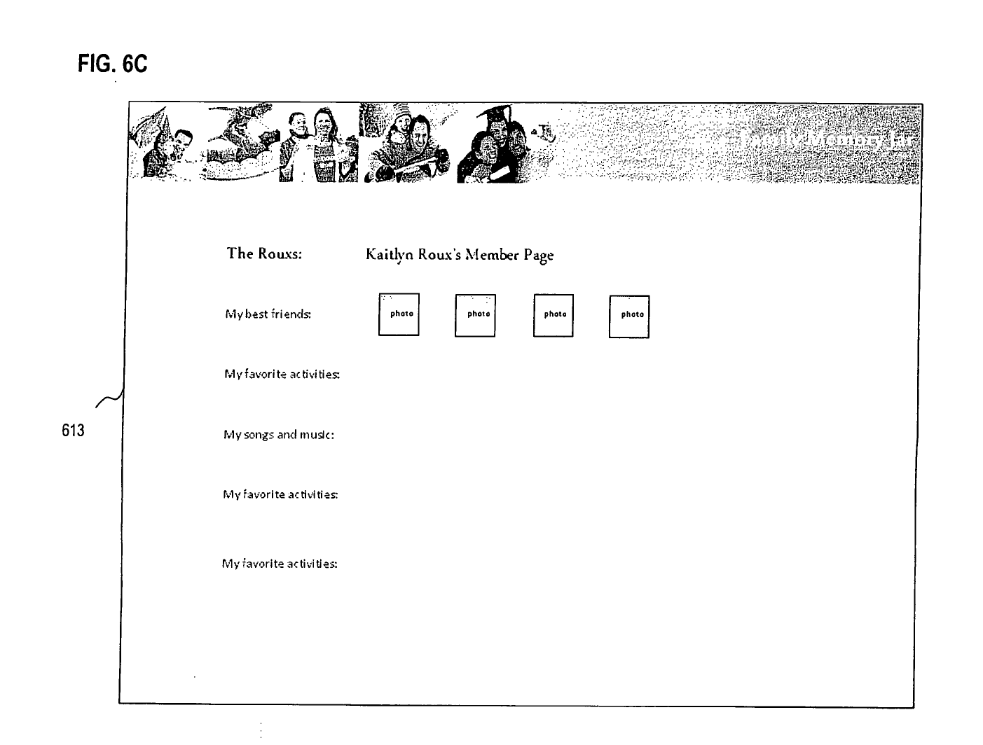

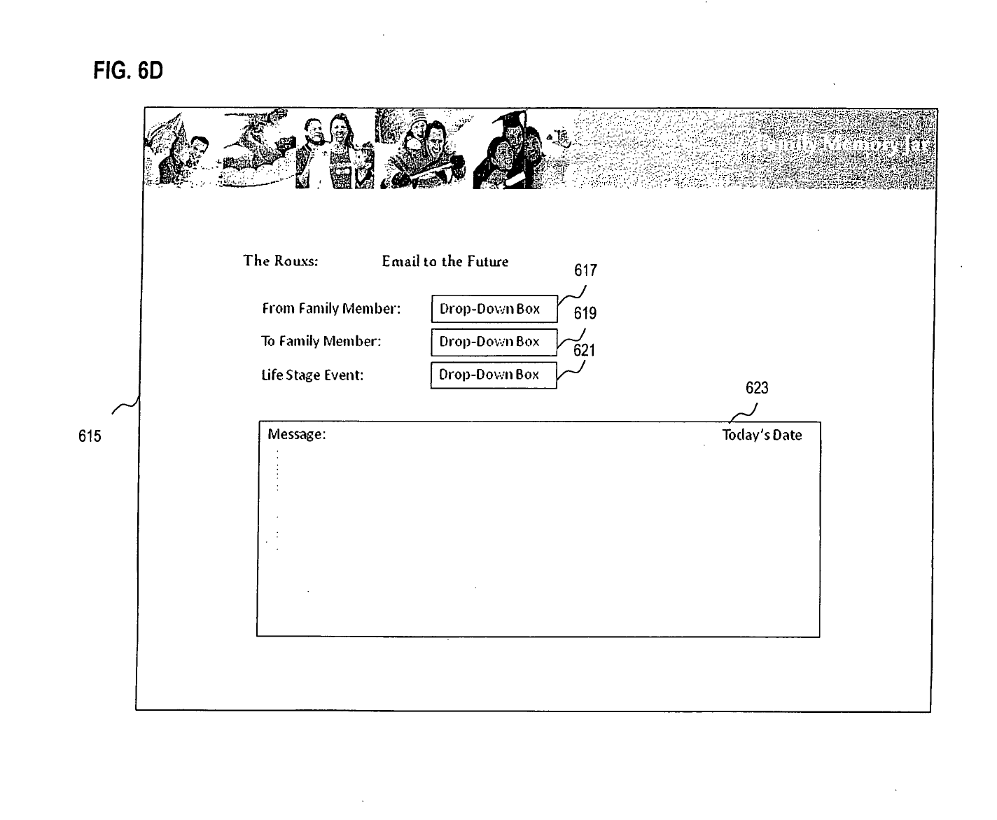

FIGS. 6A-6D depict exemplary Graphical User Interfaces (GUIs) according to various embodiments of the present invention.

FIG. 6A is an exemplary GUI 601 depicting a Main Home Page for a website employing the present invention. Registered members wishing to return to the website are asked to sign in at 801 using their user name and password, for example. In an exemplary embodiment, the user name may be a surname, an e-mail address, a name the member gives himself/herself for this account, or any other type of user identification the system and/or the member agree to use to identify the member. In typical fashion, after entering the nickname and password, the member clicks on “Sign In” at 603 to enter the website. Should the registered member forget his/her user name and/or password, the member may click on “Forgot password” at 609 and be directed, in known manner, to a site where personal information may be requested to ensure that the member is indeed that member and the nickname/password will be supplied to him/her in a known manner, e.g., by sending the information to a registered e-mail address for that member. New, or unregistered, users are given the opportunity to sign up by activating the “Register” button at 607, which directs them to a site for entering all relevant information in a known manner.

FIG. 6B is an exemplary GUI 611 depicting a family tree for a specific generation. The family tree identifies the parents, children, and children's spouses. The family administrator may modify the family tree if necessary.

FIG. 6C is an exemplary GUI 613 depicting a family member's personal page. The family member can and control access to this page as necessary.

FIG. 6D is an exemplary GUI 615 depicting an exemplary future communication page. From this page, a user can create an intra-family communication for future delivery based on the occurrence of a family event. First the user specifies a “from” address 617, a “to” address 619, an event 621 that will trigger delivery of the message, and the message contents 623.

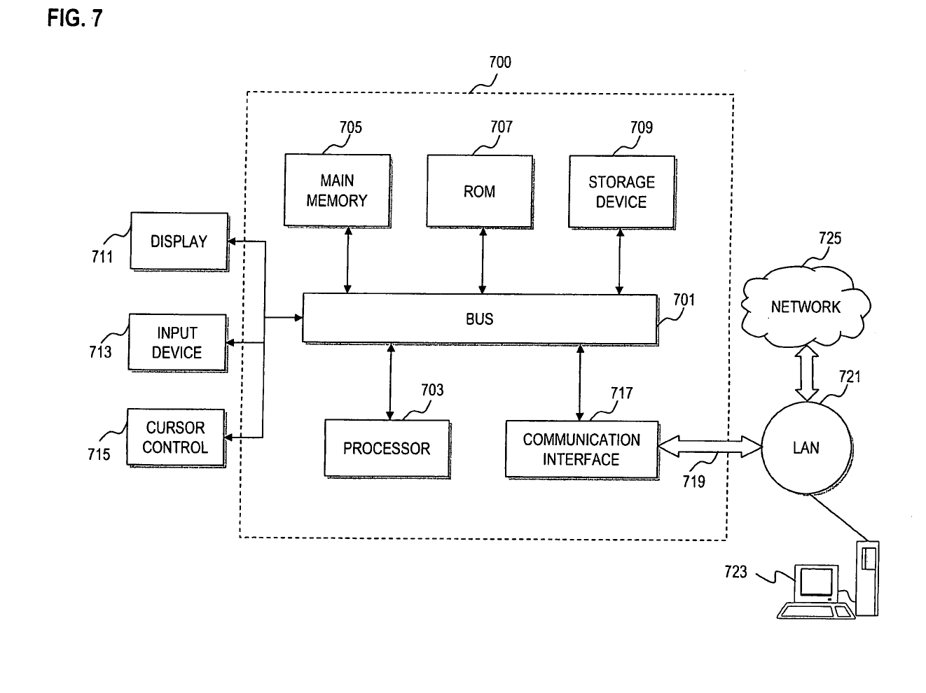

FIG. 7 illustrates a computer system 700 upon which an embodiment according to the present invention can be implemented. The computer system 700 includes a bus 701 or other communication mechanism for communicating information and a processor 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to one embodiment of the invention, the fitness analysis system is provided by the computer system 700 in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the present invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the present invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the present invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 705 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims.

What is claimed is:

1. A method comprising:
receiving input from one member of a group that includes a plurality of family members, wherein each of the members has a familial relationship with another one of the members, the input specifying a message about an event relating to another one of the members;
monitoring for occurrence of the event; and
initiating delivery of the message over a communication network based upon occurrence of the event or according to elapsed time.

2. A method according to claim 1, further comprising:
presenting a prompt offering one or more products or services to one or more of the members based on the occurrence of the event.

3. A method according to claim 1, wherein the message includes one or more of electronic mail, instant messaging, text messaging, voice messaging, multi-media messaging, multi-media files, or a combination thereof.

4. A method according to claim 1, wherein the one member utilizes either a telephony device, a mobile device, or a computer to provide the input.

5. A method according to claim 1, wherein the input is received from a web server configured to communicate with the one member via a browser.

6. A method according to claim 1, further comprising:
prompting the one member to enter information about the one member or another one of the members.

7. A method according to claim 1, further comprising:
presenting a graphical user interface that includes one of a screen displaying the familial relationship of the members, a screen displaying a member page including information about a particular member, a screen providing a text box for the message, or a combination thereof.

8. An apparatus comprising:
a communication interface configured to receive input from one member of a group that includes a plurality of family members, wherein each of the members has a familial relationship with another one of the members, the input specifying a message about an event relating to another one of the members; and
a processor configured to monitor for occurrence of the event, and to initiate delivery of the message over a communication network based upon occurrence of the event or according to elapsed time.

9. An apparatus according to claim 8, wherein the processor is configured to provide a prompt offering one or more products or services to one or more of the members based on the occurrence of the event.

10. An apparatus according to claim 8, wherein the message includes one or more of electronic mail, instant messaging, text messaging, voice messaging, multi-media messaging, multi-media files, or a combination thereof.

11. An apparatus according to claim 8, wherein the one member utilizes either a telephony device, a mobile device, or a computer to provide the input.

12. An apparatus according to claim 8, wherein the input is received from a web server configured to communicate with the one member via a browser.

13. An apparatus according to claim 8, wherein the processor is configured to prompt the one member to enter information about the one member or another one of the members.

14. An apparatus according to claim 8, wherein the processor is configured to present a graphical user interface that includes one of a screen displaying the familial relationship of the members, a screen displaying a member page including information about a particular member, a screen providing a text box for the message, or a combination thereof.

15. A system comprising:
a website configured to interact with one or more members of a family; and
an interactive family history and communication platform configured to communicate with the website for documenting family history, relationships, and events, wherein the platform is further configured to provide delivery of a message relating to a future event to a member of the family.

16. A system according to claim 15, wherein a web page on the website permits the members to identify the relationships and provide information about the members.

17. A system according to claim 15, wherein the platform is further configured to categorize the members by generation.

18. A system according to claim 15, wherein the platform is further configured to present information relevant to each member of the family, information relevant to a specific generation within the family, or information relevant to a particular one of the members.

19. A system according to claim 15, wherein the platform is further configured to offer products and services based on the occurrence of the event.

20. A system according to claim 15, wherein the platform is further configured to enable search of the family history, the relationships, the events, and messages related to the events.
